(19) United States
(12) Patent Application Publication
(10) Pub. No.: US 2011/0131010 A1
(43) Pub. Date: Jun. 2, 2011

(54) LAP TIME MEASUREMENT SYSTEM

(75) Inventors: Tae-Yun Chung, Gangneung-si (KR); Yong-Soon Park, Gangneung-si (KR); Hyung-Bong Lee, Seoul (KR)

(73) Assignee: GANGNEUNG-WONJU NATIONAL UNIVERSITY INDUSTRY ACADEMY COOPERATION GROUP, Gangneung-si (KR)

(21) Appl. No.: 13/000,649

(22) PCT Filed: Oct. 17, 2008
(86) PCT No.: PCT/KR08/06141

§ 371 Date: Feb. 4, 2011

(30) Foreign Application Priority Data
Jul. 3, 2008 (KR) 10-2008-0064183

(51) Int. Cl. G06F 19/00

(52) U.S. Cl. 702/178

(57) ABSTRACT

Disclosed herein is a lap time measurement system. The lap time measurement system includes a management server and sensor nodes deployed at respective measurement points. Each of the sensor nodes includes a Global Positioning System (GPS) reception unit, a sensor unit for detecting whether a moving object has passed through a corresponding measurement point, a communication unit for transmitting and receiving data to and from the management server, and a control unit for updating an internal timer based on the time information, determining time data of the internal timer to be passage time data, and transmitting the determined passage time data. The management server receives the passage time data from the respective sensor nodes, calculates times at which the moving object has passed through the measurement points and lap times for respective measurement intervals based on the received passage time data, and provides the calculated times and calculated lap times.

### TECHNICAL FIELD

The present invention relates, in general, to a lap time measurement system for measuring the lap times of a moving object, and, more particularly, to a lap time measurement system using a Global Positioning System (GPS) and a Ubiquitous Sensor Network (USN).

### BACKGROUND ART

A lap time measurement system is used to measure the lap times of an object that moves along a specific path. Conventional lap time measurement systems use a method using cameras or a method using Radio Frequency IDentification (RFID). A conventional lap time measurement system using cameras includes the cameras installed at respective intervals to measure the lap times of a moving object, and measures the lap times on the basis of images captured when the moving object passes through the respective intervals. However, the measurement system using the cameras is problematic in that it requires the construction of expensive equipment, many persons for the operation of the system, and high construction and maintenance costs.

Meanwhile, a lap time measurement system using RFID has problems in that it has a high measurement error rate, so that it is inappropriate for accurate lap time measurement and it cannot be applied to the lap time measurement of an object that moves across a wide area.

### DISCLOSURE

### [Technical Problem]

Accordingly, the present invention has been made keeping in mind the above problems occurring in the prior art, and an object of the present invention is to provide a lap time measurement system that is capable of measuring lap times more accurately than an existing method and being implemented at low cost without limitation on location compared to the existing method by applying time information, which is provided by a GPS, and USN technology to a lap time measurement system.

### [Technical Solution]

In order to accomplish the above object, according to a first aspect of the present invention provides, there is provided a lap time measurement system, including a management server, and a plurality of sensor nodes deployed at respective measurement points;

wherein each of the sensor nodes includes a Global Positioning System (GPS) reception unit for receiving time information from GPS satellites; a sensor unit for detecting whether a moving object has passed through a corresponding one of the measurement points; a communication unit for transmitting and receiving data to and from the management server; and a control unit for periodically updating an internal timer based on the time information received from the GPS reception unit, when the sensor unit detects passage of the moving object, determining time data of the internal timer at the time of the detection to be passage time data, and transmitting the determined passage time data to the management server; and

wherein the management server receives the passage time data from the respective sensor nodes, calculates times at which the moving object has passed through the measurement points and lap times for respective measurement intervals based on the received passage time data, and provides the calculated times and calculated lap times.

In the lap time measurement system having the above-described characteristics, the sensor nodes are respectively deployed at departure and arrival points of the moving object; and the management server receives and stores the passage time data received from the sensor nodes, calculates lap times, which it takes for the moving object to move across the intervals from the departure point to the arrival point, based on the stored passage time data, and displays the calculated lap times.

In the lap time measurement system having the above-described characteristics, the sensor nodes plural in number are deployed between departure and arrival points along a path of the moving object; and the management server stores the passage time data received from the sensor nodes, calculates lap times, which it takes for the moving object to move across the respective intervals, based on the stored passage time data, and displays the calculated lap times.

In the lap time measurement system having the above-described characteristics, each of the sensor units includes a light emission module for emitting light; a light reception module disposed on a line passing through the light emission module and a corresponding one of the measurement points, and disposed to face the light emission module so that light of the light emission module reaches the light reception module; and a signal generation module for, when the light of the light emission module is blocked by the moving object that passes through the measurement point and does not reach the light reception module, generating a sensing signal corresponding to the time of the blocking, and outputting the generated sensing signal to the control unit; and wherein when the sensing signal is received, the control unit determines time data of the internal timer at the time at which the sensing signal is received to be passage time data.

In the lap time measurement system having the above-described characteristics, the light emission module is a laser light emission module for emitting laser beams; and the light reception module is a laser light reception module for detecting laser beams.

According to a second aspect of the present invention, there is provided a lap time measurement system, including a management server, and a plurality of sensor nodes deployed at respective measurement points;

wherein each of the sensor nodes includes a sensor unit for detecting whether a moving object has passed through a corresponding one of the measurement point; a communication unit for transmitting and receiving data to and from the management server; and a control unit for updating an internal timer based on time information, which is received from the management server through the communication unit, when the sensor unit detects the passage of the moving object, determining time data of the internal timer at the time of the detection to be passage time data, and transmitting the determined passage time data to the management server; and the management server configured to have a GPS reception unit for receiving the time information from GPS satellites, to transmit the time information, received from the GPS reception unit, to the sensor nodes, to receive the passage time data from the sensor nodes, to calculate times at which the moving object has passed through the measurement points and lap times for respective measurement intervals based on the received passage time data, and to provide the calculated times and the calculated lap times.

### ADVANTAGEOUS EFFECTS

The lap time measurement system according to the present invention can measure lap times more cheaply than an existing method by using a wireless sensor network formed of sensor nodes, and can measure lap times accurately only by deploying the sensor nodes along a path without limitation on location because the synchronization between the respective sensor nodes is achieved based on time information provided by a GPS.

### DESCRIPTION OF DRAWINGS

FIG. 1 is a schematic diagram showing a lap time measurement system according to a first embodiment of the present invention;

FIG. 2 is a diagram showing the operation of a sensor unit according to the first embodiment of the present invention;

FIG. 3 is a diagram showing the operation of the lap time measurement system according to the first embodiment of the present invention;

FIGS. 4 and 5 are control flowcharts showing the operation of the lap time measurement system according to the first embodiment of the present invention; and

FIG. 6 is a schematic diagram showing a lap time measurement system according to a second embodiment of the present invention.

### BEST MODE

The construction and operation of lap time measurement systems according to embodiments of the present invention will be described in detail below with reference to the attached drawings.

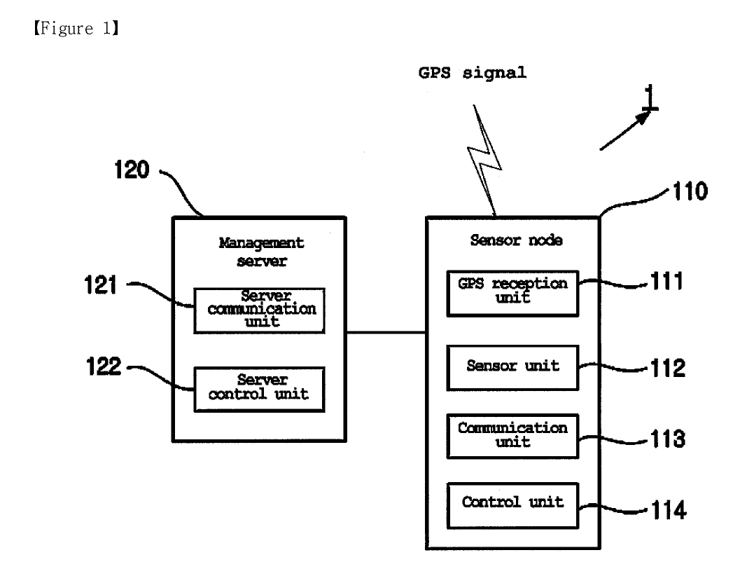

A lap time measurement system 1 according to a first embodiment of the present invention, shown in FIG. 1, includes a plurality of sensor nodes 110 and a management server 120. The sensor nodes are deployed at previously set respective measurement points. The lap time measurement system 1 according to the present embodiment will be described in brief below. The sensor nodes 110 detect pieces of time information corresponding to the respective times at which a moving object has passed through the measurement points, and transmit the detected time information to the management server 120. The management server 120 calculates the times at which the moving object has passed through measurement points and lap times for respective measurement intervals based on the time information received from the plurality of sensor nodes 110.

The elements of the lap time measurement system 1 according to the present embodiment will be described in detail below with reference to FIG. 1. First, each of the sensor nodes 110 according to the present embodiment will be described below with reference to FIG. 1. The sensor node 110 includes a GPS reception unit 111, a sensor unit 112, a communication unit 113, and a control unit 114. The sensor node 110 functions to receive time information from the GPS reception unit, periodically update an internal timer, detect the passage time corresponding to a corresponding passage point of a moving object using the internal timer, and transmit the detected passage time to the management server 120.

The GPS reception unit 111 receives time information from GPS satellites. The GPS reception unit 111 of the present embodiment has a maximum time error of 167 ns within a horizontal location range of 100 m and a vertical location range of 156 m.

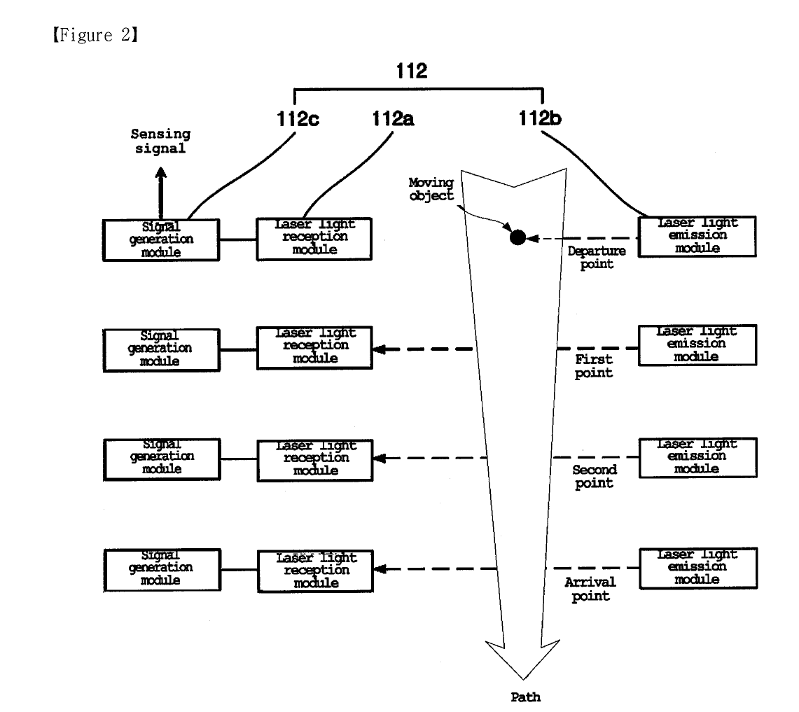

The sensor unit 112 functions to detect whether a moving object has passed through a previously set measurement point. The sensor unit 112, as shown in FIG. 2, includes a laser light reception module 112a, a laser light emission module 112b, and a signal generation module 112c. The moving object moves along a path shown in FIG. 2. The laser light reception module 112a is an optical sensor for generating current corresponding to a laser beam when the laser beam is incident thereon. FIG. 2 shows the time at which a laser beam emitted from the laser light emission module 112b deployed at a departure point is not incident on the laser light reception module 112a due to the moving object. The laser light emission module 112b is equipped with a laser resonator for emitting laser beams, and is disposed so that the laser beams emitted therefrom are directly incident on the laser light reception module 112. Here, the laser light emission module 112b is preferably disposed to face the laser light reception module 112a across a previously set measurement point, as shown in FIG. 2. The laser light emission module and laser light reception module of the sensor unit 112 may be provided as laser sensors having a wavelength of 660 nm the response speed of which is 5000 Hz. In this case, the expected delay error of sensor response time is a maximum of 200 μs. In the case where a laser beam emitted from the laser light emission module 112b when the moving object passes through the measurement point is blocked by the moving object and therefore does not reach the laser light reception module 112a, the signal generation module 112c generates a sensing signal corresponding to the time at which the laser beam is blocked by the moving object and outputs the generated sensing signal to the control unit 114.

The communication unit 113 functions to transmit data to the management server 120 over a communication network. Here, the communication network may be provided as a wired/wireless communication network, but a Code Division Multiple Access (CDMA) network may be considered for the communication network.

The control unit 114 periodically updates an internal timer (not shown) using time information received by the above-described GPS reception unit 111, determines the time data of the internal timer to be passage time data when a sensing signal is received from the sensor unit 112, and transmits the passage time data to the management server 120 through the communication unit 113.

The management server 120 will be described below with reference to FIG. 1. The management server 120, as shown in FIG. 1, includes a server communication unit 121 and a server control unit 122. The server communication unit 121 receives passage time data from the plurality of sensor nodes 110 over a communication network. The server control unit 122 provides passage times for corresponding measurement points based on the passage time data received from the server communication unit 121, or calculates and provides lap times for respective measurement intervals.

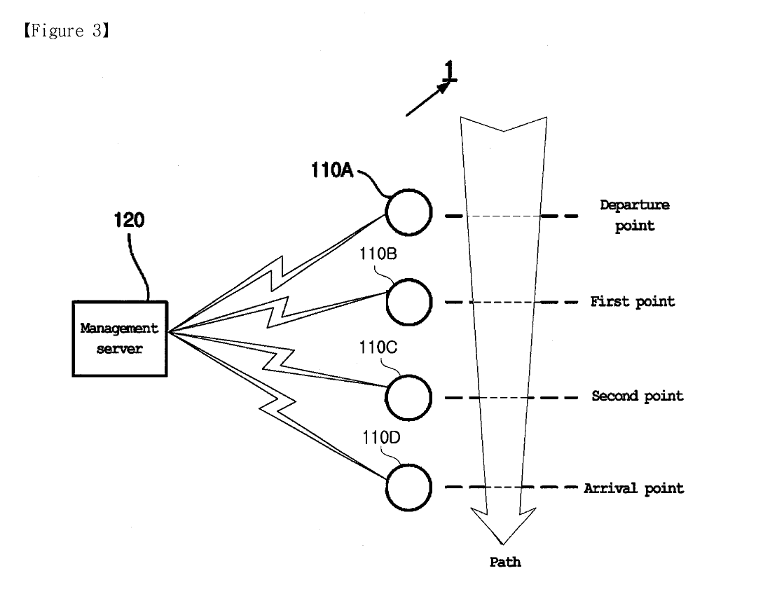

FIG. 3 shows the lap time measurement system 1 having four sensor nodes 110A, 110B, 110C and 110D deployed along the path of a moving object. Referring to FIG. 3, the moving object will pass through a departure point, a first point, a second point, and an arrival point along the path. The sensor nodes measure passage time data for measurement points, and provide the measured passage time data to the management server. The management server calculates passage times for the measurement points and lap times for respective measurement intervals based on the passage time data transmitted from the sensor nodes, and provides the calculated passage times and lap times.

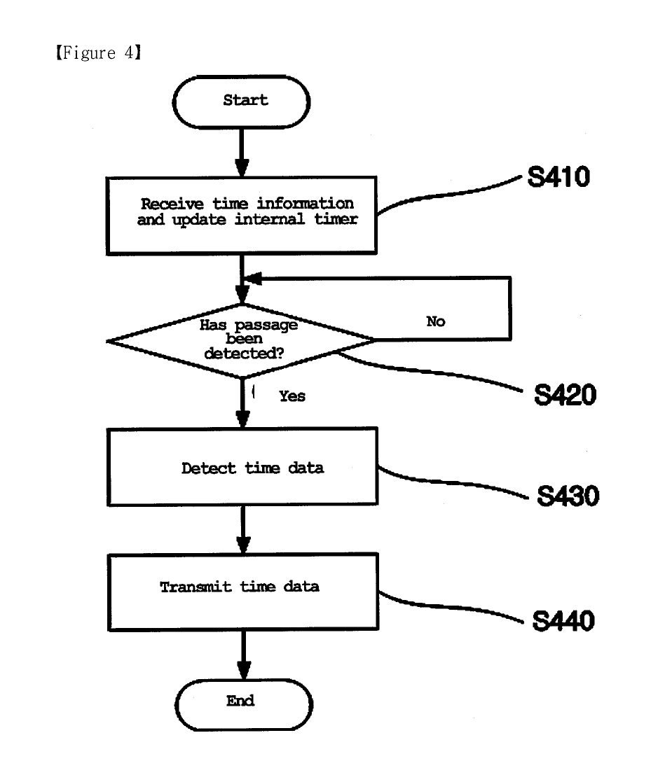

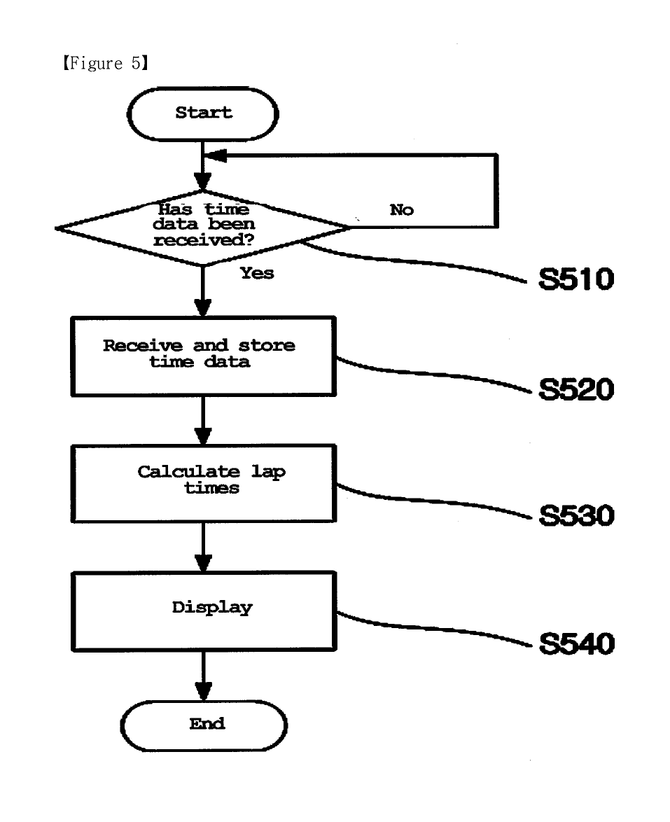

The operation of the lap time measurement system according to the first embodiment of the present invention will be described below with reference to FIGS. 4 and 5. FIG. 4 is a flowchart of the control unit of the sensor node, which is shown to illustrate the operation of the sensor node 110 shown in FIG. 3. The operation of the sensor node 110 will be described below with reference to FIG. 4. Here, a control routine in which the sensor node 110 detects the passage of a moving object is described. Such a control routine is performed by the control unit 114 of the sensor node 110.

First, the sensor node 110 periodically updates the time data of the internal timer based on time information received from the GPS reception unit 111 in step 5410. In the case where the time data of the internal timer of the sensor node 110 is updated every 5 seconds based on the received time information, the time error attributable to time drift, which is generated in an internal crystalline oscillator, may also be corrected.

Thereafter, the sensor node 110 determines whether the moving object has passed through a corresponding measurement point in step S420. More specifically, when the moving object passes through the sensor unit 112 disposed at the departure point shown in FIG. 2, the sensor node 110 generates a sensing signal and outputs the sensing signal to the control unit 114. The control unit 114 determines whether the moving object has passed through the measurement point based on whether the sensing signal has been input. If, as a result of the determination in step S420, the moving object is determined not to have passed through the measurement point, the sensor node 110 returns to the step S420. However, if, as a result of the determination in step S420, the moving object is determined to have passed through the measurement point, the sensor node 110 reads the time data of the internal timer at this time and detects passage time data in step S430. Thereafter, the sensor node 110 transmits the passage time data to the management server 120. Such transmission may be performed over a wired/wireless communication network, and may also be performing using a CDMA network.

FIG. 5 is a control flowchart showing the operation of the management server 120 shown in FIG. 3. The operation of the management server 120 will be described below with reference to FIG. 5. Here, a control routine in which the management server 120 processes the lap times of a moving object will be described. This control routine is performed by the server control unit 122 of the management server 120.

First, the management server 120 determines whether pieces of passage time data have been received from the respective sensor nodes in step S510. If, as a result of the determination in step S510, the pieces of passage time data are determined not to have been received, the management server 120 returns to the step S510. If, as a result of the determination in step S510, the pieces of passage time data are determined to have been received, the management server 120 stores the received passage time data in step S520. Thereafter, the management server 120 calculates lap times for respective measurement intervals using the stored passage time data in step S530. A description is given with reference to that shown in FIG. 3. It is assumed that a moving object has passed through the sensor node 110A disposed at the departure point at the time “A”, the sensor node 110B deployed at the first point at the time “B”, and the sensor nodes 110C and 110D deployed at the second and arrival points at the times “C” and “D”. In this case, the lap time between the departure and arrival points is calculated by “D-A”, and the lap time between the first and second points is calculated by “C-B.” Thereafter, the management server 120 converts the lap times, calculated in step S530, to image signals, and displays the image signals on a display unit (not shown).

The accuracy of measurement according to the first embodiment is checked by roughly calculating the measurement error of the lap time measurement system 1 according to the first embodiment. For example, in the case where the control unit 114 of the sensor node 110 operates at 400 MHz and the response speed of the sensor unit 112 is 5000 Hz, the sensor response time delay is expected to be a maximum of about 200 μs. The error attributable to the time drift of the crystalline oscillator can be maintained within an error of 0.1 ms in the case where the time data of the internal timer is updated every cycle of 5 seconds based on received time information. Accordingly, a maximum measurement error according to the first embodiment corresponds to about 0.3 ms, and measurement can be performed every 1/2000 second. Since the time error, which is generated when the above-described GPS reception unit 111 receives time information, is 167 ns and minute, it is excluded from the calculation.

### MODE FOR INVENTION

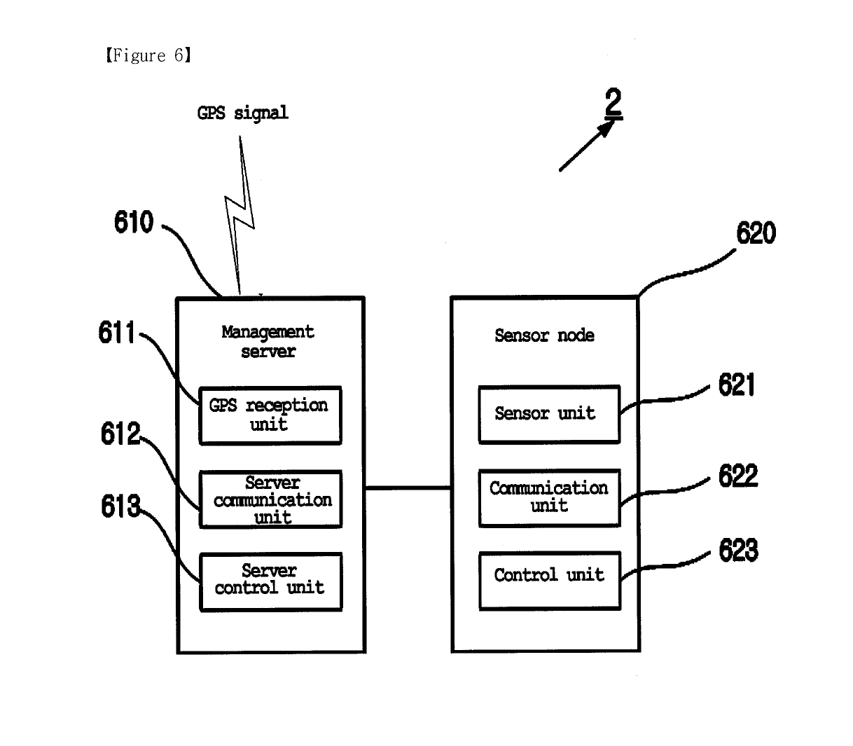

A lap time measurement system 2 according to a second embodiment of the present invention will be described below with reference to FIG. 6. The lap time measurement system 2 according to the second embodiment of the present invention includes a management server 610 and a plurality of sensor nodes 620, like that of the first embodiment. The sensor nodes are deployed at respective measurement points. The lap time measurement system 2 according to the present embodiment will be described in brief. The management server 610 receives time information from a GPS, and periodically transmits the time information to the sensor nodes 620. The sensor nodes 620 detect pieces of time information corresponding to the corresponding passage points of a moving object, and transmit the detected time information to the management server 610. The management server 610 calculates the passage times of the moving object and lap times for respective measurement intervals based on the time information received from the sensor nodes 620. The elements of the lap time measurement system 2 according to the present embodiment will be described in detail below with reference to FIG. 6. A description of content identical to that of the above-described first embodiment will be omitted here.

The management server 610 will be described below with reference to FIG. 6. The management server 610 includes a GPS reception unit 611, a server communication unit 612 and a server control unit 613, and periodically receives time information from GPS satellites and transmits the received time information to the sensor nodes. The GPS reception unit 611 receives time information from GPS satellites, and the time information may also be used as information for time synchronization in the field of mobile communication. The server communication unit 612 transmits the time information, received by the GPS reception unit 611, to the sensor nodes 620 over a communication network. In the case where a CDMA network is used, the server communication unit 612 transmits a communication signal, including the received time information, to the sensor nodes 620 for time synchronization. Furthermore, the server communication unit 612 receives passage time data from the sensor nodes 620, which will be described later, over a communication network. The server control unit 613 processes the passage time data received through the server communication unit 612, calculates passage times for measurement points and lap times for respective measurement intervals, and displays them on a display unit (not shown).

The sensor nodes 620 will be described with reference to FIG. 6 below.

Each of the sensor nodes 620 includes a sensor unit 621, a communication unit 622, and a control unit 623. The sensor node 620 functions to receive time information from the management server 610, detect passage time corresponding to a corresponding passage point of a moving object based on the received time information, and transmit the detected passage time to the management server 610. The sensor unit 621 determines whether a moving object has passed through a corresponding measurement point. If, as a result of the determination, the moving object is determined to have passed through the measurement point, the sensor unit 621 generates a sensing signal corresponding to the passage time, and outputs it to the control unit 623.

The communication unit 622 receives time information from the management server 610 over a communication network, and outputs the time information to the control unit 623. Here, the communication network may be provided as a wired/wireless communication network. In the case where a CDMA network is used as the communication network, the communication unit 622 outputs a communication signal, including time information, to the control unit 623. Furthermore, the communication unit 622 transmits passage time data, generated by the control unit 623, to the management server 610.

The control unit 623 updates an internal timer (not shown) based on the time information received from the communication unit 622. When the sensor unit 621 detects the passage of the moving object, the control unit 623 reads the time data of the internal timer at the time of the passage, determines passage time data, and transmits the determined passage time data to the management server 610 through the communication unit 622. For example, in the case where a communication network is a CDMA network, the control unit 623 must extract time information, included in a communication signal input by the communication unit 622, from the communication signal.

In the present embodiment, the sensor node 620 may extract time information from a communication signal, which is transmitted over a CDMA network, about 125 times per second, and may update the time data of the internal timer. Accordingly, time synchronization can be performed within a delay error of about 8 ms. Furthermore, the control unit 623 synchronizes the time data of the internal timer at regular intervals in order to correct time error attributable to time drift, which is generated in an internal crystalline oscillator. Here, the control unit 623 performs a synchronization task every 50 seconds in order to correct the time error. Accordingly, the measurement error can be maintained within 1 ms. The schematic operation of the lap time measurement system 2 according to the second embodiment of the present invention will be described below. In the case where the specific operation of each of the elements identical to that of the first embodiment, a description thereof will be omitted here.

The management server 610 receives time information from a GPS, and transmits the received time information to the sensor nodes 620 at regular intervals. Each of the sensor nodes 620 updates time data recorded in its internal timer based on the time information received from the management server 610. Here, in the case where the received time information is included in a communication signal transmitted over a CDMA network, a process of extracting the time information from the communication signal must be performed. In the present embodiment, each of the sensor nodes 620 may extract time information from a communication signal, which is transmitted over a CDMA network, about 125 times per second, and may update the time data of the internal timer thereof. That is, the time synchronization can be performed within an error of about 8 ms. When a moving object passes through measurement points, the sensor nodes 620 detect respective passage times, determine the time data of the internal timers at the time of the detection to be passage time data, and transmit the determined passage time data to the management server 610. The management server 610 stores the passage time data received from the sensor nodes 620, calculates lap times based on the passage time data, and displays the calculated lap times.

The accuracy of measurement according to the second embodiment is checked by roughly calculating the measurement error of the lap time measurement system 1 according to the second embodiment. For example, in the case where the control unit 623 of each of the sensor nodes 620 operates at 400 MHz and the response speed of the sensor unit 621 is 5000 Hz, sensor response time delay is expected to be a maximum of about 200 μs. In the case where error attributable to the time drift of the crystalline oscillator is corrected every 50 seconds, the error can be maintained within 1 ms and a delay error of 8 ms may occur in processes of time information reception and synchronization over a CDMA network. Accordingly, a maximum measurement error according to the second embodiment corresponds to about 9.2 ms, and measurement may be performed every 1/100 second. Since the time error, which is generated when the above-described GPS reception unit 611 receives time information, is 167 ns and minute, it is excluded from the calculation.

Although the second embodiment has lower measurement accuracy than the first embodiment, the time information, transmitted from the management server 610 to the each sensor node 620, is used to synchronize the internal timer of the sensor node, so that it is not necessary to install the GPS reception unit 611 in the sensor node 620. Accordingly, the second embodiment 2 may be constructed more cheaply than the first embodiment 1. In particular, in the case where a CDMA network is used as the communication network, it is easy to implement the second embodiment 2 because time information included in a communication signal can be used.

### INDUSTRIAL APPLICABILITY

The lap time measurement system according to the present invention is used to measure the lap times of an object that moves along a specific path, and can be used in a variety of fields, requiring the automatic measurement of lap times, particularly in recording sporting events such as athletic sports and skiing.

1. A lap time measurement system, comprising:
a management server, and a plurality of sensor nodes deployed at respective measurement points;
wherein each of the sensor nodes comprises:
a Global Positioning System (GPS) reception unit for receiving time information from GPS satellites;
a sensor unit for detecting whether a moving object has passed through a corresponding one of the measurement points;
a communication unit for transmitting and receiving data to and from the management server; and
a control unit for periodically updating an internal timer based on the time information received from the GPS reception unit, when the sensor unit detects passage of the moving object, determining time data of the internal timer at the time of the detection to be passage time data, and transmitting the determined passage time data to the management server; and
wherein the management server receives the passage time data from the respective sensor nodes, calculates times at which the moving object has passed through the measurement points and lap times for respective measurement intervals based on the received passage time data, and provides the calculated times and calculated lap times.

2. The lap time measurement system according to claim 1, wherein:
the sensor nodes are respectively deployed at departure and arrival points of the moving object; and
the management server receives and stores the passage time data received from the sensor nodes, calculates lap times, which it takes for the moving object to move across the intervals from the departure point to the arrival point, based on the stored passage time data, and displays the calculated lap times.

3. The lap time measurement system according to claim 1, wherein:
the sensor nodes plural in number are deployed between departure and arrival points along a path of the moving object; and
the management server stores the passage time data received from the sensor nodes, calculates lap times, which it takes for the moving object to move across the respective intervals, based on the stored passage time data, and displays the calculated lap times.

4. The lap time measurement system according to claim 1, wherein:
each of the sensor units comprises:
a light emission module for emitting light;
a light reception module disposed on a line passing through the light emission module and a corresponding one of the measurement points, and disposed to face the light emission module so that light of the light emission module reaches the light reception module; and
a signal generation module for, when the light of the light emission module is blocked by the moving object that passes through the measurement point and does not reach the light reception module, generating a sensing signal corresponding to the time of the blocking, and outputting the generated sensing signal to the control unit; and
wherein when the sensing signal is received, the control unit determines time data of the internal timer at the time at which the sensing signal is received to be passage time data.

5. The lap time measurement system according to claim 4, wherein:
the light emission module is a laser light emission module for emitting laser beams; and
the light reception module is a laser light reception module for detecting laser beams.

6. A lap time measurement system, comprising:
a management server, and a plurality of sensor nodes deployed at respective measurement points;
wherein each of the sensor nodes comprises:
a sensor unit for detecting whether a moving object has passed through a corresponding one of the measurement point;
a communication unit for transmitting and receiving data to and from the management server; and
a control unit for updating an internal timer based on time information, which is received from the management server through the communication unit, when the sensor unit detects the passage of the moving object, determining time data of the internal timer at the time of the detection to be passage time data, and transmitting the determined passage time data to the management server; and
the management server configured to have a GPS reception unit for receiving the time information from GPS satellites, to transmit the time information, received from the GPS reception unit, to the sensor nodes, to receive the passage time data from the sensor nodes, to calculate times at which the moving object has passed through the measurement points and lap times for respective measurement intervals based on the received passage time data, and to provide the calculated times and the calculated lap times.

7. The lap time measurement system according to claim 6, wherein the communication network is a Code Division Multiple Access (CDMA) network.

8. The lap time measurement system according to claim 7, wherein the time information, which is transmitted from the management server to the sensor nodes, is included in a synchronization signal used for time synchronization in the CDMA network.
